(19) United States
(12) Patent Application Publication
(10) Pub. No.: US 2026/0061579 A1
(43) Pub. Date: Mar. 5, 2026

(54) PIPE DISMANTLING DEVICE

(71) Applicant: Jun-Fan CHEN, Taichung City (TW)

(72) Inventor: Jun-Fan CHEN, Taichung City (TW)

(21) Appl. No.: 19/090,779

(22) Filed: Mar. 26, 2025

(30) Foreign Application Priority Data
Aug. 30, 2024 (TW) 113132753

(51) Int. Cl. B25B 27/28

(52) U.S. Cl. CPC B25B 27/28

(57) ABSTRACT

A pipe dismantling device configured to separate a target object from a pipe is provided, wherein the pipe dismantling device includes: a main body configured to engage the target object, including two arm members rotatably which are connected to each other and are openable and closeable relative to each other, the two arm members defining a receiving space configured to receive the pipe, free ends of the two arm members defining a notch therebetween.

### BACKGROUND OF THE INVENTION

### Field of the Invention

The present invention relates to a dismantling device, particularly to a pipe dismantling device.

### Description of the Prior Art

The transmission of fluids often requires the use of a plurality of pipes connected to each other to form a flow passage. Sealing elements such as O-rings are also sleeved between two connected pipes. Therefore, when maintenance or replacement is needed, the pipes and sealing elements must first be disassembled. Conventional methods for removing pipes or sealing elements mostly involve direct manual operation or using pliers to clamp and pull them apart forcefully.

However, when personnel encounter conditions such as excessively high or low fluid temperatures in the pipes, excessive debris in the surrounding environment, or a limited range of motion, manual operation becomes unfeasible. Additionally, if the pipe is a hose, using pliers to clamp and pull it may easily damage its structure, making it unusable after disassembly. This results in unnecessary waste and increases replacement costs.

The present invention is, therefore, arisen to obviate or at least mitigate the above-mentioned disadvantages.

### SUMMARY OF THE INVENTION

The main object of the present invention is to provide a pipe dismantling device which can quickly and effectively disassemble a target object sleeved on a pipe.

To achieve the above and other objects, a pipe dismantling device configured to separate a target object from a pipe is provided, wherein the pipe dismantling device includes: a main body configured to engage the target object, including two arm members rotatably which are connected to each other and are openable and closeable relative to each other, the two arm members defining a receiving space configured to receive the pipe, free ends of the two arm members defining a notch therebetween.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is a side view of FIG. 1;

FIG. 3 is an exploded view of FIG. 1;

FIG. 4 is a cross-sectional view of free ends of two arm members moving toward each other to an extreme position in an exemplary embodiment of the present invention;

FIG. 5 is a cross-sectional view of the free ends of the two arm members moving away from each other to an extreme position in an exemplary embodiment of the present invention; and

FIGS. 6 to 9 illustrate operational steps of an exemplary embodiment of the present invention.

### DETAILED DESCRIPTION OF THE PREFERRED EMBODIMENTS

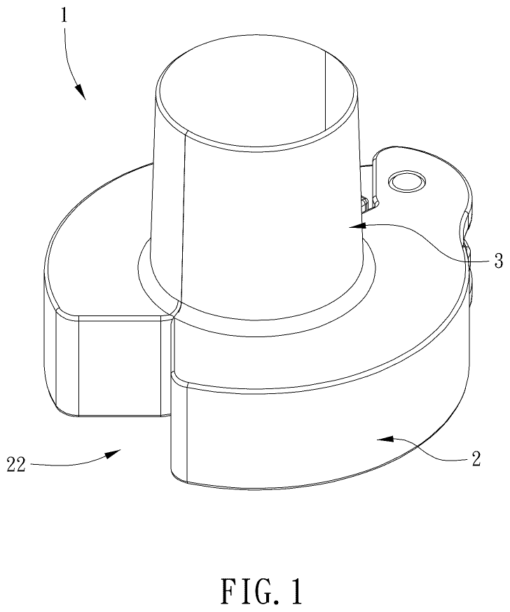

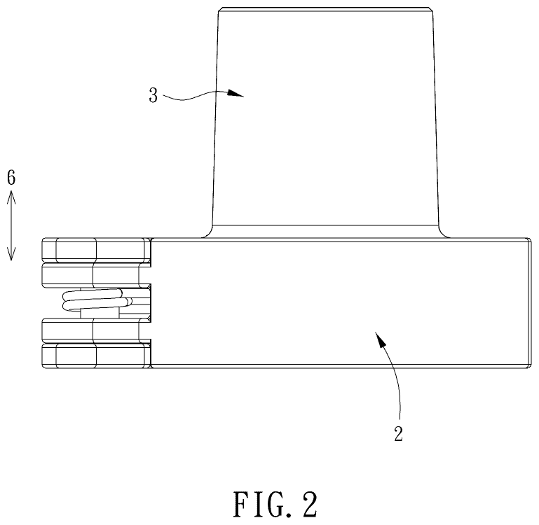

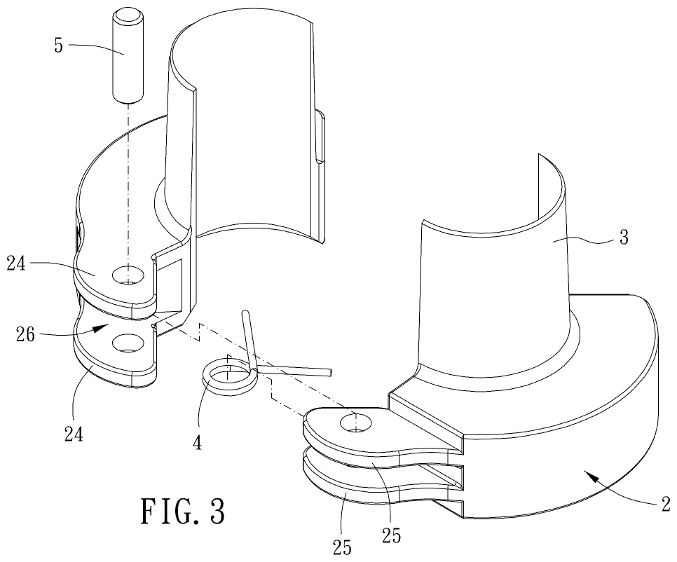

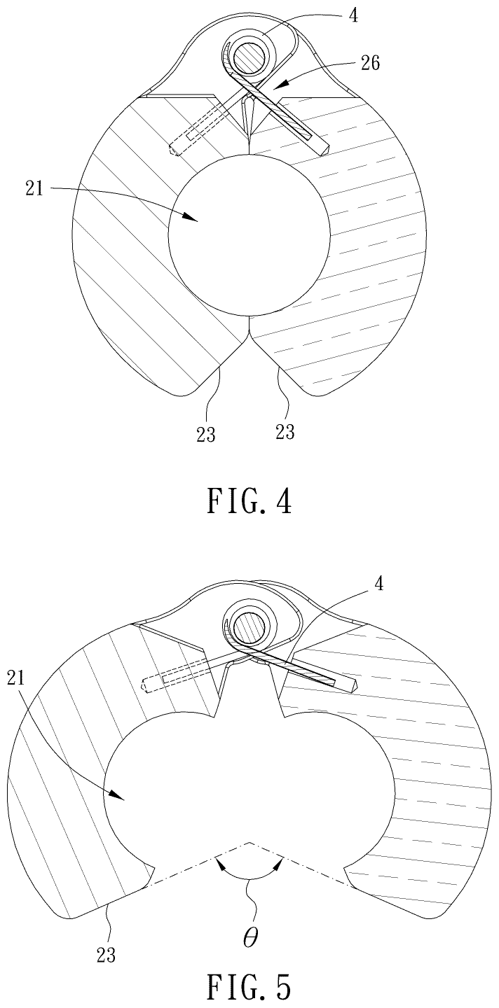

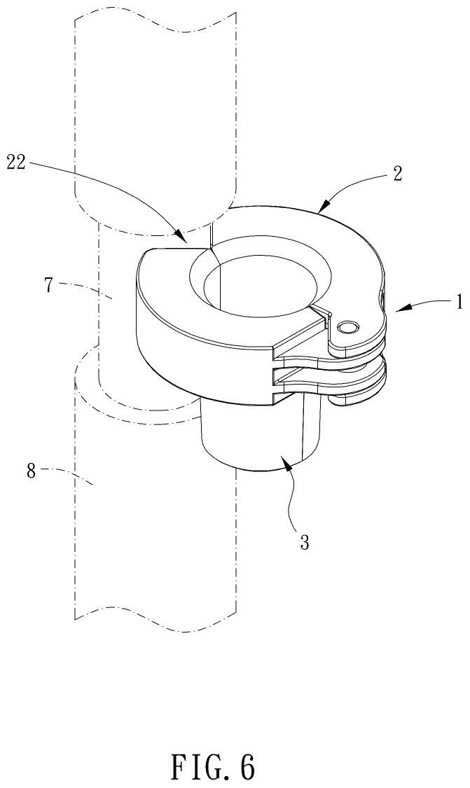

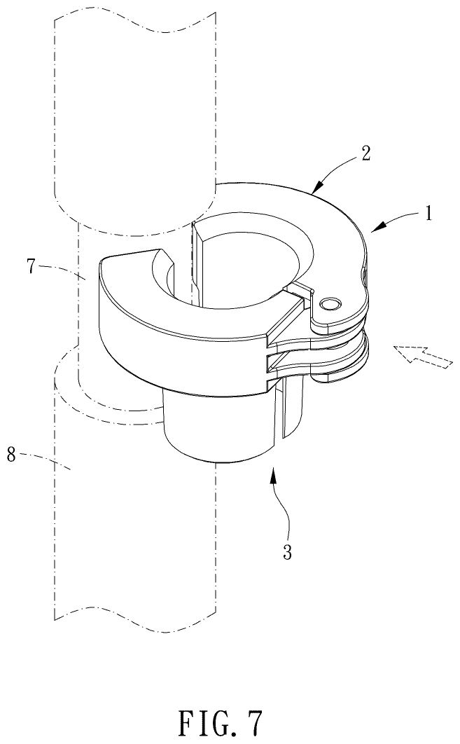

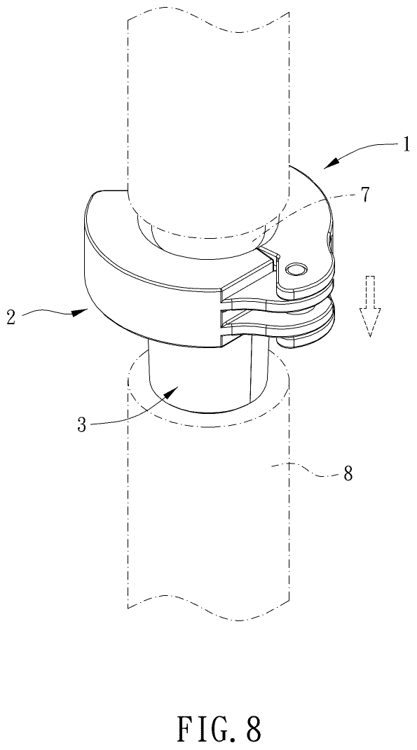

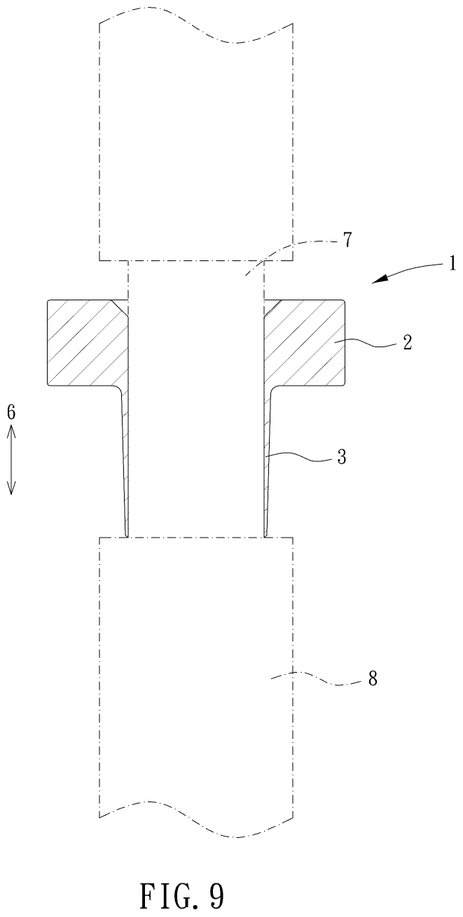

Please refer to FIGS. 1 to 6 for an exemplary embodiment of the present invention. A pipe dismantling device of the present invention is configured to separate a target object 8 from a pipe 7. The target object 8 may include, but is not limited to, pipes (such as oil pipes), gaskets, bushings, and other sleeved objects. The pipe dismantling device includes a main body 1.

The main body 1 is configured to engage the target object 8. The main body 1 includes two arm members 2 which are rotatably connected to each other and are openable and closeable relative to each other. The two arm members 2 define a receiving space 21 configured to receive the pipe 7. Free ends of the two arm members 2 define a notch 22 therebetween. During operation, the main body 1 is held and moved toward the pipe 7 with the notch 22 facing the pipe 7. As the main body 1 moves, part of the pipe 7 enters the notch 22 and forces the two arm members 2 apart, thereby allowing the main body 1 to be laterally engaged with the pipe 7.

More specifically, each of the two arm members 2 further includes an inclined guide surface 23 disposed on an end surface of its free end. The inclined guide surfaces 23 of the two arm members 2 define the notch 22. When the free ends of the two arm members 2 move toward each other to an extreme position, the notch 22 gradually expands in a direction away from the receiving space 21. The gradually expanding notch 22 facilitates the entry of the pipe 7.

In this embodiment, when the free ends of the two arm members 2 move toward each other to an extreme position, portions of the free ends of the two arm members 2 abut each other, and the inclined guide surfaces 23 of the two arm members 2 are disposed perpendicularly, thereby providing both the opening angle of the notch 22 and structural strength at the free ends. Moreover, when the free ends of the two arm members 2 move away from each other to an extreme position, an included angle θ formed by extensions of the inclined guide surfaces 23 of the two arm members 2 is greater than 130 degrees, providing a wide range of opening angles for the two arm members 2, enabling engagement with the pipe 7 having a larger diameter.

Preferably, the main body 1 further includes an elastic member 4, and the elastic member 4 abuts the two arm members 2 so that the free ends of the two arm members 2 tend to move toward each other. In other words, when the pipe 7 enters the receiving space 21, the two arm members 2, driven by the elastic member 4, automatically engage the pipe 7.

Specifically, one of the two arm members 2 further includes two first connection portions 24 which are spaced apart to define an assembly slot 26. The other of the two arm members 2 further includes at least one second connection portion 25, and the at least one second connection portion 25 is inserted in the assembly slot 26. The two first connection portions 24 and the second connection portion 25 are rotatably connected together by at least one pivot 5. In this embodiment, an other of the two arm members 2 includes two second connection portions, and the two second connection portions are inserted in the assembly slot 26. The two first connection portions and the two second connection portions are rotatably connected together by a pivot 5. The pivot 5 and the elastic member 4 are made of metal, and the elastic member 4 is inserted in one of the two arm members 2. Specifically, the elastic member 4 is sleeved on the pivot 5 and is inserted in the two arm members 2. In this manner, the elastic member 4 is effectively hidden within the two arm members 2, not only preventing external objects from contacting the elastic member 4 but also maintaining a simple and clean visual appearance of the main body 1.

Preferably, the main body 1 further includes at least one abutment portion 3, and the at least one abutment portion 3 is disposed on at least one of the two arm members 2 and is configured to engage the target object 8. The at least one abutment portion 3 can push or expand against the target object 8, facilitating separation of the target object 8 from the pipe 7. The structure allows usage in confined spaces while ensuring hand safety and preventing damage to both the pipe 7 and the target object 8.

Specifically, the receiving space 21 extends along a first direction 6, and the at least one abutment portion 3 protrudes from the at least one of the two arm members 2 in the first direction 6. Accordingly, when the main body 1 is fitted onto the pipe 7, a usage method involves the user driving the main body 1 to move along the extending direction of the pipe 7, thereby allowing the at least one abutment portion 3 to push against the target object 8 and separate it from the pipe 7. More specifically, in a direction perpendicular to the first direction 6, a ratio of a maximum dimension of the at least one abutment portion 3 to a maximum dimension of the arm member 2 ranges from 0.1 to 0.3, thereby limiting the size of the at least one abutment portion 3. As a result, in addition to pushing against the target object 8 as described above, the at least one abutment portion 3 can even extend into the interior of the target object 8 for pushing or expanding purposes.

Preferably, the at least one abutment portion 3 and the connected arm member 2 are integrally formed of one piece, providing advantages of superior structural continuity, elimination of assembly requirements, and rapid production.

In this embodiment, the at least one abutment portion includes two abutment portions 3 which are respectively disposed on the two arm members 2. Each of the two abutment portions 3 and one of the two arm members 2 are integrally formed by plastic injection molding, and each of the two abutment portions 3 has an arcuate tubular shape. The two abutment portions 3 and the two arm members 2 are preferably coaxially arranged.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A pipe dismantling device configured to separate a target object from a pipe, the pipe dismantling device including:
a main body configured to engage the target object, including two arm members rotatably which are connected to each other and are openable and closeable relative to each other, the two arm members defining a receiving space configured to receive the pipe, free ends of the two arm members defining a notch therebetween.

2. The pipe dismantling device of claim 1, wherein the main body further includes at least one abutment portion, and the at least one abutment portion is disposed on at least one of the two arm members and is configured to engage the target object.

3. The pipe dismantling device of claim 2, wherein the receiving space extends along a first direction, and the at least one abutment portion protrudes from the at least one of the two arm members in the first direction.

4. The pipe dismantling device of claim 2, wherein the at least one abutment portion and the at least one of the two arm members are integrally formed of one piece.

5. The pipe dismantling device of claim 3, wherein, in a direction perpendicular to the first direction, a ratio of a maximum dimension of the at least one abutment portion to a maximum dimension of the at least one of the two arm members is ranges from 0.1 to 0.3.

6. The pipe dismantling device of claim 1, wherein each of the two arm members further includes an inclined guide surface disposed on an end surface of the free end thereof, the inclined guide surfaces of the two arm members define the notch, and when the free ends of the two arm members move toward each other to an extreme position, the notch gradually expands in a direction away from the receiving space.

7. The pipe dismantling device of claim 6, wherein when the free ends of the two arm members move away from each other to an extreme position, an included angle formed by extensions of the inclined guide surfaces of the two arm members is greater than 130 degrees.

8. The pipe dismantling device of claim 1, wherein the main body further includes an elastic member, the elastic member abuts the two arm members so that the free ends of the two arm members tend to move toward each other.

9. The pipe dismantling device of claim 8, wherein one of the two arm members further includes two first connection portions, the two first connection portions are spaced apart to define an assembly slot, an other of the two arm members further includes at least one second connection portion, the at least one second connection portion is received in the assembly slot, the two first connection portions and the at least one second connection portion are rotatably connected together by at least one pivot, and the elastic member is inserted in one of the two arm members.

10. The pipe dismantling device of claim 3, wherein the at least one abutment portion and the at least one of the two arm members are integrally formed of one piece; in a direction perpendicular to the first direction, a ratio of a maximum dimension of the at least one abutment portion to a maximum dimension of the at least one of the two arm members is ranges from 0.1 to 0.3; each of the two arm members further includes an inclined guide surface disposed on an end surface of the free end thereof, the inclined guide surfaces of the two arm members define the notch, and when the free ends of the two arm members move toward each other to an extreme position, the notch gradually expands in a direction away from the receiving space; when the free ends of the two arm members move away from each other to an extreme position, an included angle formed by extensions of the inclined guide surfaces of the two arm members is greater than 130 degrees; the main body further includes an elastic member, the elastic member abuts the two arm members so that the free ends of the two arm members tend to move toward each other; one of the two arm members further includes two first connection portions, the two first connection portions are spaced apart to define an assembly slot, an other of the two arm members further includes two second connection portions, the two second connection portions are inserted in the assembly slot, and the two first connection portions and the two second connection portions are rotatably connected together by a pivot; the elastic member is sleeved on the pivot; wherein the elastic member is inserted in the two arm members; the at least one abutment portion includes two abutment portions, the two abutment portions are respectively disposed on the two arm members; when the free ends of the two arm members move toward each other to an extreme position, portions of the free ends of the two arm members abut each other, and the inclined guide surfaces of the two arm members are disposed perpendicularly; each of the two abutment portions has an arcuate tubular shape; the two abutment portions and the two arm members are coaxially arranged; each of the two abutment portions and one of the two arm members are integrally formed by plastic injection molding; the pivot and the elastic member are made of metal.
